(19) United States
(12) Patent Application Publication
(10) Pub. No.: US 2018/0337737 A1
(43) Pub. Date: Nov. 22, 2018

(54) COMMUNICATION SYSTEM NETWORK

(71) Applicant: WFS Technologies LTD, Livingston (GB)

(72) Inventor: Brendan Peter Hyland, Edinburgh (GB)

(73) Assignee: WFS Technologies LTD, Livingson (GB)

(21) Appl. No.: 15/776,890

(22) PCT Filed: Nov. 18, 2016
(86) PCT No.: PCT/GB2016/000205

§ 371 Date: May 17, 2018

(30) Foreign Application Priority Data
Nov. 18, 2015 (GB) 1520340.9

(51) Int. Cl. H04B 13/02; H04W 4/38

(52) U.S. Cl. CPC H04B 13/02; H04W 84/20; H04W 4/38

(57) ABSTRACT

A wireless communication system network for use with at least one underwater structure, the said communication system network comprising a plurality of communications units disposed around the underwater structure, each communication unit comprising a wireless transmitter, and a wireless receiver, wherein each communication unit is arranged with communicable range of at least three other communication units to form a mesh of communication units operable to work as a network and each communication unit is operable to perform as a master communication unit to at least one of transmit and receive data from the communication system network. The network may extend across multiple static or mobile underwater structures and may be a dynamic network.

The present invention relates to a communication system network for an underwater structure and, in particular, a communication system wireless mesh network for facilitating structural monitoring and integrity management.

As energy requirements increase, technology is being developed to find and exploit new energy sources in our oceans. Offshore wind farms are being constructed and tidal power generators are seeing a resurgence in interest. Oil and gas exploration and production is also venturing further into deeper waters. As a result large numbers of subsea installations are being constructed. In many instances control modules are located upon the installations together with process sensors, to control and operate the facilities, as a result, control and monitoring data needs to be relayed to and from the control modules and sensors.

In GB2,458,944, Vetco Gray Controls Limited have considered control module provision for a hydrocarbon extraction plant. Communication between a topside facility of a hydrocarbon extraction plant and Subsea Control Modules (SCMs) at an underwater hydrocarbon extraction installation of the plant, for example at a “Christmas tree” associated with a hydrocarbon extraction well, is currently effected by the use of copper or fibre-optic cables within an umbilical line, which connects the topside communications equipment to the subsea field. Likewise, Subsea Production Control System process sensors, mounted on a subsea Christmas tree, manifold or other structure, are currently connected by copper wires to the Subsea Control Module (SCM). Both these types of connection require Electrical Flying Leads (EFLs). The capital, topside and subsea installation costs of EFLs forms a significant portion, approximately 15%, of the overall cost of a Subsea Production Control System suite of equipment. Due to the electro-mechanical nature of the connectors, combined with the need to be wet-mateable for recovery, for example, of SCMs and/or sensors, the reliability of EFLs has historically been poor. EFLs can also cause problems during Remote Operation Vehicle (ROV) operations such as the recovery of a failed SCM or the updating of software. The topside to SCM umbilical line typically carries control and monitoring signals via a modem, whereas an SCM provides DC power and Fieldbus serial communications (e.g. Profibus, Modbus, (ANBus, etc) to the sensors and relays the sensor data to the topside equipment via the umbilical. GB 2 458 944 removes the need for most of the EFLs and their associated expensive electrical connectors for communication in a hydrocarbon extraction plant by providing a method of enabling communication between components of a hydrocarbon extraction plant or Christmas tree, the plant having an underwater hydrocarbon extraction installation including at least one hydrocarbon extraction well, and comprises providing a plurality of Radio Frequency (RF) communication means at components of the installation. The method may comprise a subsea control module, a sensor, a remotely operated vehicle (ROV), a repeater or a battery. The RF communication means can each transfer control, monitoring and sensor data to the subsea control module (SCM). The SCM communicates wirelessly with the ROV then enables the transmission of control signals and return of monitoring signals so that they can implement or record data as is needed. However, this individual communication between the ROV and each SCM and, in turn the SCM and each sensor unit, means that failure of the SCM causes the entire system to be out of communication until the SCM is replaced.

Due to the harsh environments of subsea and the operating depths from surface, the process of SCM replacement is both expensive and fraught with difficulties. In addition, during the period of time when the SCM is being replaced, the entire system is unable to communicate with the ROV and thus no data relating to the system can be provided to the surface control centre.

It is an object of the present invention to provide a communication system network for an subsea installation which obviates or mitigates at least some of the disadvantages in the prior art.

According to a first aspect of the invention there is provided a wireless communication system network for use with an underwater structure, the said communication system network comprising a plurality of communications units disposed around the underwater structure, each communication unit comprising a wireless transmitter and a wireless receiver wherein each communication unit is arranged with communicable range of at least three other communication units to form a mesh of communication units operable to work as a network and each communication unit is operable to perform as a master communication unit to at least one of transmit and receive data from the communication system network.

By providing a mesh of wireless communication units which are within communicable range of at least three other communication units, in the event of one communication unit failure, data can still be transmitted to and from other communication units and as any of the units can operate as the master unit to transmit and receive data from the network to an external communication unit meaning that even during failure of one communication unit, the system is still able to receive and provide data from and to an external control centre.

Each communication unit may be provided with a processor unit. Each processor unit may be operable to carry out processing on the data, implement data control and instruct transmission and reception of data from and to the communication unit to a desired other communication unit or external communication device as required and according to predetermined criteria if set.

Each processor unit may be operable to determine whether that communication unit is to operate as a master communication unit and transmit data to and receive data from a remote communication mechanism.

Each communication unit may be associated with a sensor operable to sense or detect data relating to the underwater structure, each communication unit may be provided with a recording unit operable to receive data and a data logger unit operable to store data collected by the associated sensor. By recording and storing sensor data related to the underwater structure, the communication unit can make the data available for later transmission if required.

Preferably, the sensors are intergral with a communication unit, alternatively the sensors may be wirelessly connected to the associated communication unit. Preferably data transmission between each communication unit and another communication unit or a sensor unit is bi-directional. In this way, command and control signals can be transferred to the sensor or to a communication unit.

Preferably the one or more sensors include an integrity monitoring sensor. More preferably, the one or more sensors include a sensor for monitoring cathodic protection. Alternatively, the one or more sensors are measurement devices and may be selected from gauges, sensors, valves, sampling devices, a device used in intelligent or smart well completion, temperature sensors, pressure sensors, flow-control devices, flow rate measurement devices, oil/water/gas ratio measurement devices, scale detectors, actuators, locks, release mechanisms, equipment sensors (e.g., vibration sensors), sand detection sensors, water detection sensors, strain gauges, data recorders, viscosity sensors, density sensors, bubble point sensors, composition sensors, resistivity array devices and sensors, acoustic devices and sensors, other telemetry devices, near infrared sensors, gamma ray detectors, H₂S detectors, CO₂ detectors, downhole memory units, downhole controllers, and locators.

Each communication unit transceiver and receiver may be provided as a transceiver.

Preferably, each transceiver has an electrically insulated magnetic coupled antenna. Alternatively, each transceiver has an electric field coupled antenna. The antenna may be a wire loop, coil or similar arrangement. Such antenna create both magnetic and electromagnetic fields. The magnetic or magneto-inductive field is generally considered to comprise two components of different magnitude that, along with other factors, attenuate with distance (r), at rates proportional to 1/r² and 1/r³ respectively. Together they are often termed the near field components. The electromagnetic field has a still different magnitude and, along with other factors, attenuates with distance at a rate proportional to 1/r. It is often termed the far field or propagating component.

Preferably, the data is transmitted as an electromagnetic and/or magneto-inductive signal. Signals based on electrical and electromagnetic fields are rapidly attenuated in water due to its partially electrically conductive nature. Propagating radio or electromagnetic waves are a result of an interaction between the electric and magnetic fields. The high conductivity of seawater attenuates the electric field. Water has a magnetic permeability close to that of free space so that a purely magnetic field is relatively unaffected by this medium. However, for propagating electromagnetic waves the energy is continually cycling between magnetic and electric field and this results in attenuation of propagating waves due to conduction losses. The seawater provides attenuation losses in a workable bandwidth which still provide for data transmission over practical distances.

Data transmitted from each communication unit may be compressed prior to transmission. In this way the occupied transmission bandwidth can be reduced. This allows use of a lower carrier frequency which leads to lower attenuation. This in turn allows data transfer through fluids over greater transmission distances. In this way, the first range can be increased by lowering the carrier frequency.

The underwater structure may be one of a group comprising: a rig, a blow-out preventor, a lower stack, a wellhead, a Christmas tree, a wind power generator support, a wave power generator, a separator, a pump, a manifold and a compressor.

Embodiments of the present invention will now be described, by way of example only, with reference to the accompanying drawings of which:

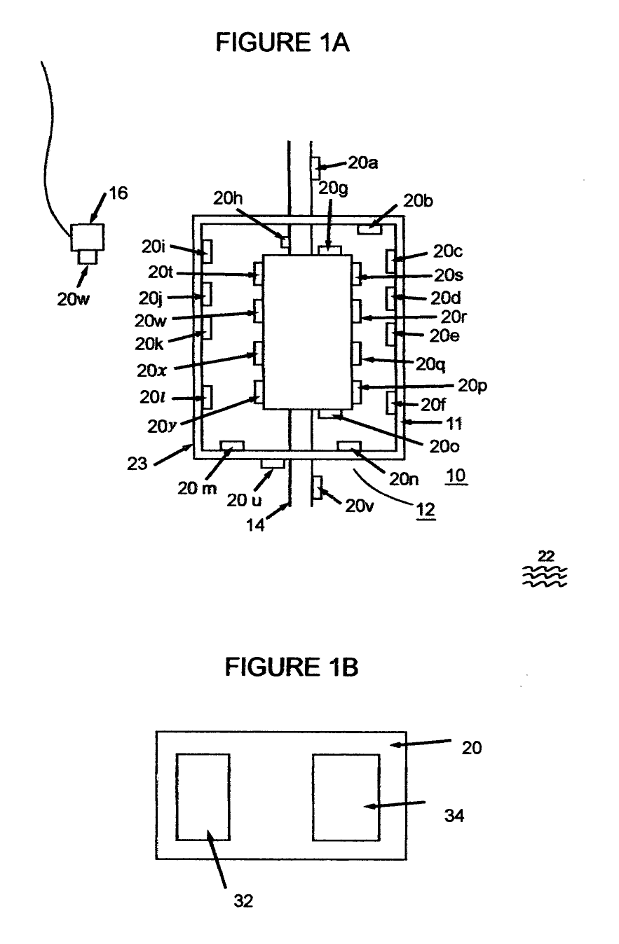

FIG. 1A is a schematic illustration of a subsea structure including a communication system network according to an embodiment of the present invention;

FIG. 1B is a schematic illustration of a communication unit for use in a system of the present invention;

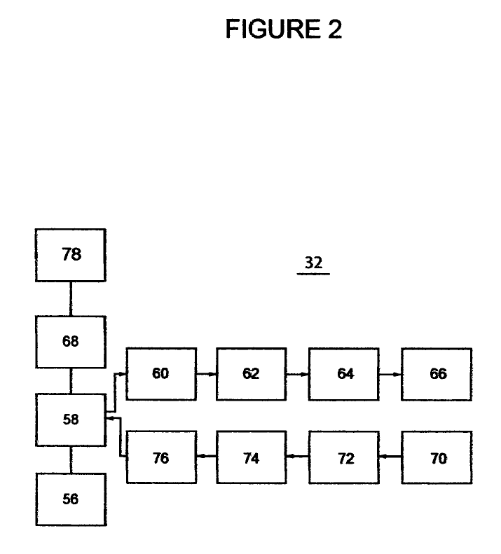

FIG. 2 is a block diagram of a transceiver for use in a communication unit of the present invention, and

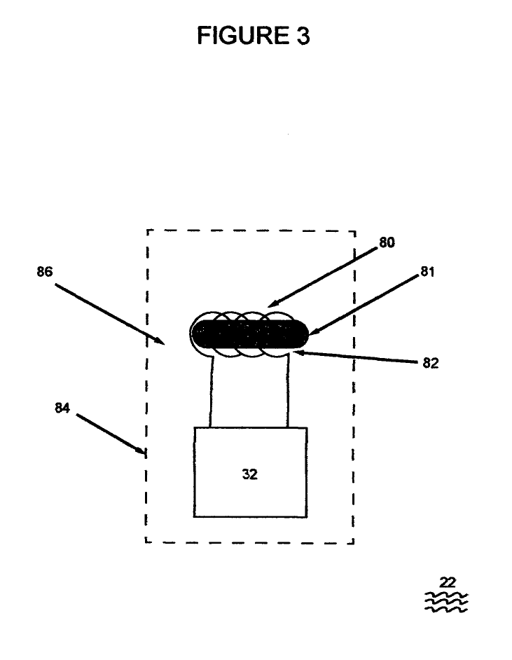

FIG. 3 is a block diagram of an antenna for use in the transmitter or receiver of the transceiver of FIG. 2.

Reference is initially made to FIG. 1A of the drawings which illustrates a subsea structure, generally indicated by reference numeral 10, provided with a communication system network 12, the system network 12 being used to monitor and manage the integrity of the the subsea installation 10 according to an embodiment of the present invention.

In FIG. 1A, the subsea installation 10 is a blow out preventer (BOP) structure 11 connected to a riser 14. As the structure 10 is underwater within the harsh environment of the sea, it is liable to corrosion and tidal movement can cause stress and strain to the structure of the structure 11 and riser 14. In order to monitor the integrity of the installation 10, communication units 20a-v are located on the installation 10 across BOP structure 11 and the section of riser 14 on which the BOP is mounted. There is further provided a Remotely Operated Vehicle (ROV) upon which is mounted a communication unit 20w.

As can be seen in FIG. 1B, each communication unit 20 is provided with a transceiver 32 and a sensor unit 34.

In use, for example, communication unit 20v, located on the riser 14, monitors stress on the structure by measuring temperature, movement, pressure and strain as sensor unit 34v will include the sensors and monitors for these purposes. Alternatively, for example, communication unit 20h, located on the upright 23, has a sensor unit 34h provided with sensors and monitors to record potential and current density meaning it is able to monitor the performance of a cathodic protection system for corrosion monitoring. Other sensors units 34, associated with communication units 20a-v respectively, can include sensors and measurement devices selected from gauges, sensors, valves, sampling devices, a device used in intelligent or smart well completion, temperature sensors, pressure sensors, flow-control devices, flow rate measurement devices, oil/water/gas ratio measurement devices, scale detectors, actuators, locks, release mechanisms, equipment sensors (e.g., vibration sensors), sand detection sensors, water detection sensors, data recorders, viscosity sensors, density sensors, bubble point sensors, composition sensors, resistivity array devices and sensors, acoustic devices and sensors, other telemetry devices, near infrared sensors, gamma ray detectors, H₂S detectors, CO₂ detectors, downhole memory units, downhole controllers, and locators.

The system network 12 is thus operable to record data pertaining to the integrity and surrounding environment of the structure 10. Each communication unit 20a-v is located such that it is within wirelessly communicable distance of three other communication units, so unit 20k is within communicable distance of unit 201, unit 20j and unit 20i. The communication units 20 are such that they can network data transmission and provide alternating and varying data transmission routes across the mesh of communication units 20. Each communication unit 20 is able to transmit and receive data from the transceiver 20w of ROV 16 which can retrieve data from the installation 10 and provide it to a remote control centre, such as an above water control ship (not shown).

The mesh network 12 can either be arranged such that each unit 20a-v communicates with the ROV in turn or as needed, or a single communication unit, in this case unit 20i, can be chosen as a master unit with all network collected data from units 20a-v transmitted across the mesh network 12 to the master unit 20i for onward transmission to ROV 16. Alternatively command data can be input from the ROV 16 by transmission from communications units 20w, to an individual communication unit 20i from where it is distributed across the network. Yet further alternatively, the ROV 16 can provide input data to single units for their use only.

Reference is now made to FIG. 2 of the drawings which illustrates parts of each transceiver 32. In transceivers 32 the sensor interface 56 receives data from the measurement systems in the sensors units 34. The measured data is forwarded to data processor 58. Data is then passed from data processor 58 to signal processor 60 which generates a modulated signal which is modulated onto a carrier signal by modulator 62. Transmit amplifier 64 then generates the desired signal amplitude required by transmit transducer 66. In the transceiver 36, there also is a control interface 68 which sends command signals to the data processor 58 which are transmitted by the above described path. These command signals can be used to detect the location of a wireless transceiver 32 to determine which other transceivers 32 of other communication units 20 are within proximity for data transmission and reception and which, or whether all, of these are the most suitable for communication.

The transceivers 32 also have a receive transducer 70 which receives a modulated signal which is amplified by receive amplifier 72. Demodulator 74 mixes the received signal to base band and detects symbol transitions. The signal is then passed to signal processor 76 which processes the received signal to extract data. Data is then passed to data processor 58 which in turn forwards the data to control interface 68. Each transceiver 32 also has a memory 78 which can store data for onward transfer.

FIG. 3 shows an example of an antenna 80 that can be used in the transmitter and receiver 32 of FIG. 2. The antenna 80 has a high permeability ferrite core 81. Wound round the core are multiple loops 82 of an insulated wire. The number of turns of the wire and length to diameter ratio of the core 81 can be selected depending on the application. However, for operation at 125 kHz, one thousand turns and a 10:1 length to diameter ratio is suitable. The antenna is connected to the relevant transmitter/receiver assembly parts 32 described in FIG. 2 and is included in a sealed housing 84. It will be appreciated that the sensor units 34 of unit 20 of FIG. 2 may be incorporated in sealed housing 84 (not shown). Within the housing the antenna may be surrounded by air or some other suitable insulator 86, for example, low conductivity medium such as distilled water that is impedance matched to the prompting medium 22. While a transceiver 32 is described with a common antenna for transmit and receive, it will be appreciated that separate antennas may be used. Additionally, a separate transmitter coil arrangement can be provided solely for power transfer should such functionality be required.

In use, each communication unit 20a-v is provided with a sensor unit 34a-v and is installed on the blow out preventer 10. The communication units 20a-v may be fitted during the construction phase or alternatively they may be retrofitted to take measurements when required. The sensors 34 can be programmed to make measurements at predetermined intervals and save the data in an on board memory 78. When the data requires to be retrieved, the ROV 16 including a communication unit 20w, travels underwater to the location. At or near the location, transceivers 32 of communication units 20a-v will identify themselves to the transceiver 32w of communication unit 20w when in range. Data can then be transferred by the process described with reference to FIG. 2. The ROV 16 can be separately positioned relative to each communication unit 20a-v and the ROV 16 can collect data from a specific communication unit, for example communication unit 20i, or any other communication unit, then repositioned next to another communication unit 20m, or any other communication unit, to collect further data. Alternatively, the ROV 16 can be positioned next to any chosen communication unit 20, which is determined by the mesh network to be the master communication unit for the system 12. In this way the communication units 20 are sealed for life sensors and communication units as the data is harvested wirelessly. The collected data can then be downloaded from the ROV 16. Advantageously, an ROV 16 can harvest all the data from all the communication units located on the subsea installation 12 in a single trip and should any single communication unit 20 be faulty or damaged, this will not prevent data being harvested from all other communication units within the mesh network 12. Alternatively, the ROV can be selective in which sensors it collects data from and/or to.

It will be appreciated that the network 12 may extend beyond an installation and incorporate multiple installations and the communication units may be deployed on static or mobile structures which allow the network boundaries to vary dynamically.

The principle advantage of the present invention is that it provides a communication system network for a subsea installation which can use sealed for communication units for data recordal and harvest wirelessly. These communication units offer the opportunity to mount any number of communication units on a subsea installation and thus provide improved integrity management of the installation.

A further advantage of at least one embodiment of the present invention is that it provides a system for monitoring a subsea installation which can provide back-up for real time control in the event of failure any one of the communication units.

A yet further advantage of at least one embodiment of the present invention is that it provides a system for monitoring a subsea installation which with the monitoring able to be relayed even in the event of failure of one of the communication units.

It will be appreciated by those skilled in the art that various modifications may be made to the invention herein described without departing from the scope thereof. For example, the mobile underwater vehicle may be a manned submarine. The mobile underwater vehicle may be used to transfer data and control signals between communication unit or communication unit sensors located on the subsea installation or between subsea installations. It will be further understood that while each communication unit 20 is shown with an integral sensor 34, the sensors 34 may be separate from the communication unit 20 and communicate with the associated communication unit 20 by way of wireless data transmission or a cabled connection.

1-21. (canceled)

22. A wireless communication system network for use with at least one underwater structure, the said communication system network comprising:
a plurality of communications units disposed around the underwater structure, each communication unit comprising a wireless transmitter, and
a wireless receiver,
wherein each communication unit is arranged with communicable range of at least three other communication units to form a mesh of communication units operable to work as a network and each communication unit is operable to perform as a master communication unit to at least one of transmit and receive data from the communication system network.

23. A wireless communication system as claimed in claim 22 wherein each communication unit is provided with a processor unit.

24. A wireless communication system as claimed in claim 23 wherein each processor unit is operable to carry out at least one of processing on the data, implementing data control and instructing transmission and reception of data from and to the communication unit to a desired other communication unit or external communication device.

25. A wireless communication system as claimed in claim 23 wherein each processor unit is operable to determine whether the associated communication unit is to operate as a master communication unit.

26. A wireless communication system as claimed in claim 22 wherein each communication unit is associated with at least one sensor.

27. A wireless communication system as claimed in claim 22 wherein each communication unit is provided with a recording unit.

28. A wireless communication system as claimed in claim 22 wherein each communication unit is provided with a data logger unit.

29. A wireless communication system as claimed in claim 26 wherein the at least one sensor is integrated with a communication unit.

30. A wireless communication system as claimed in claim 26 wherein the at least one sensor is wirelessly connected to the associated communication unit.

31. A wireless communication system as claimed in claim 22 wherein data transmission between a communication unit and at least one of another communication unit is bi-directional.

32. A wireless communication system as claimed in claim 26 wherein data transmission between a communication unit and at least one sensor is bi-directional.

33. A wireless communication system as claimed in claim 26 wherein the at least one sensor includes an integrity monitoring sensor.

34. A wireless communication system as claimed in claim 26 wherein the at least one sensor includes a sensor for monitoring cathodic protection.

35. A wireless communication system as claimed in claim 26 wherein the at least one sensor is at least one measurement device and is selected from one or more of gauges, sensors, valves, sampling devices, a device used in intelligent or smart well completion, temperature sensors, pressure sensors, flow-control devices, flow rate measurement devices, oil/water/gas ratio measurement devices, scale detectors, actuators, locks, release mechanisms, equipment sensors (e.g., vibration sensors), sand detection sensors, water detection sensors, strain gauges, data recorders, viscosity sensors, density sensors, bubble point sensors, composition sensors, resistivity array devices and sensors, acoustic devices and sensors, other telemetry devices, near infrared sensors, gamma ray detectors, H2S detectors, CO2 detectors, downhole memory units, downhole controllers, and locators.

36. A wireless communication system as claimed in claim 22 wherein each communication unit transceiver and receiver is a transceiver.

37. A wireless communication system as claimed in claim 36 wherein each transceiver has an electrically insulated magnetic coupled antenna.

38. A wireless communication system as claimed in claim 36 wherein each transceiver has an electric field coupled antenna.

39. A wireless communication system as claimed in claim 22 wherein the data is transmitted as an electromagnetic and/or magneto-inductive signal.

40. A wireless communication system as claimed in claim 22 wherein the data transmitted from each communication unit is compressed prior to transmission.

41. A wireless communication system as claimed in claim 22 wherein the structure is a fixed structure.

42. A wireless communication system as claimed in claim 22 wherein the structure is a mobile structure.

43. A communication unit for use in a wireless communication system of claim 22.
